(19) United States
(12) Patent Application Publication
(10) Pub. No.: US 2004/0193833 A1
(43) Pub. Date: Sep. 30, 2004

(54) Physical mode addressing

(76) Inventors: Kathryn Hampton, Los Gatos, CA (US); Jeffrey Hilland, Cypress, TX (US); Paul R. Culley, Tomball, TX (US); David J. Garcia, Los Gatos, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/401,232

(22) Filed: Mar. 27, 2003

(51) Int. Cl. G06F 12/10

(52) U.S. Cl. 711/206; 711/202

(57) ABSTRACT

The disclosed embodiments may relate to an address translation mechanism that may include a request that corresponds to a memory access operation. The request may include an address mode field. The address translation mechanism may also include an address field that may be used as a virtual address or a physical address depending on the contents of the address mode field.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

In the field of computer systems, it may be desirable for information to be transferred from a system memory associated with one computer system to a system memory associated with another computer system. Queue pairs (“QPs”) may be used to facilitate such a transfer of data. Each QP may include a send queue (“SQ”) and a receive queue (“RQ”) that may be utilized in transferring data from the memory of one device to the memory of another device. The QP may be defined to expose a segment of the memory within the local system to a remote system. Memory windows may be used to ensure that memory exposed to remote systems may be accessed by designated QPs. The information about the memory windows and memory regions may be maintained within a memory translation and protection table (“TPT”). Steering tags (“Stags’) may be used to direct access to a specific entry within the TPT. Each of these memory regions and memory windows may be accessed through an STag.

However, before the memory may be accessed via memory windows, either locally or remotely, the memory windows may first be registered. This registration process may consume computing overhead and may create excessive entries in the hardware memory translation logic.

### BRIEF DESCRIPTION OF THE DRAWINGS

The foregoing and other advantages of the invention may become apparent upon reading the following detailed description and upon reference to the drawings in which:

FIG. 1 is a block diagram illustrating a computer network in accordance with embodiments of the present invention;

FIG. 2 is a block diagram illustrating a simplified exchange between computers in a computer network in accordance with embodiments of the present invention;

FIG. 3 is a block diagram showing the processing of a memory request and associated TPT information for a multi computer system in accordance with embodiments of the present invention; and

FIG. 4 is illustrates a process in accordance with embodiments of the present invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The Remote Direct Memory Access (“RDMA”) Consortium, which includes the assignee of the present invention, is developing specifications to improve ability of computer systems to remotely access the memory of other computer systems. One such specification under development is the RDMA Consortium Protocols Verb specification, which is hereby incorporated by reference. The verbs defined by this specification may correspond to commands or actions that may form a command interface for data transfers between memories in computer systems, including the formation and management of queue pairs, memory windows, protection domains and the like.

RDMA may refer to the ability of one computer to directly place information in the memory space of another computer, while minimizing demands on the central processing unit (“CPU”) and memory bus. In an RDMA system, an RDMA layer may interoperate over any physical layer in a Local Area Network (“LAN”), Server Area Network (“SAN”), Metropolitan Area Network (“MAN”), or Wide Area Network (“WAN”).

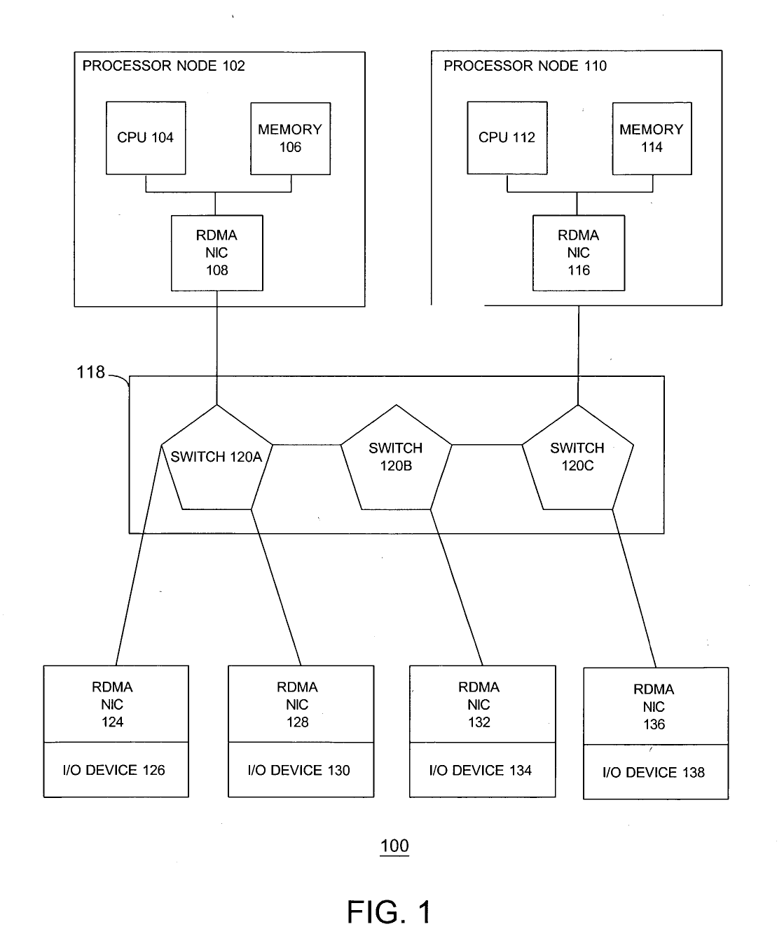

Referring now to FIG. 1, a block diagram illustrating a computer network in accordance with embodiments of the present invention is illustrated. The computer network is indicated by the reference numeral 100 and may comprise a first processor node 102 and a second processor node 110, which may be connected to a plurality of I/O devices 126, 130, 134, and 138 via a switch network 118. Each of the I/O devices 126, 130, 134 and 138 may utilize a Remote Direct Memory Access-enabled Network Interface Card (“RNIC”) to communicate with the other systems. In FIG. 1, the RNICs associated with the I/O devices 126, 130, 134 and 138 are identified by the reference numerals 124, 128, 132 and 136, respectively. The I/O devices 126, 130, 134, and 138 may access the memory space of other RDMA-enabled devices via their respective RNICs and the switch network 118.

The topology of the network 100 is for purposes of illustration only. Those of ordinary skill in the art will appreciate that the topology of the network 100 may take on a variety of forms based on a wide range of design considerations. Additionally, NICs that operate according to other protocols, such as InfiniBand, may be employed in networks that employ such protocols for data transfer.

The first processor node 102 may include a CPU 104, a memory 106, and an RNIC 108. Although only one CPU 104 is illustrated in the processor node 102, those of ordinary skill in the art will appreciate that multiple CPUs may be included therein. The CPU 104 may be connected to the memory 106 and the RNIC 108 over an internal bus or connection. The memory 106 may be utilized to store information for use by the CPU 104, the RNIC 108 or other systems or devices. The memory 106 may include various types of memory such as Static Random Access Memory (“SRAM”) or Dynamic Random Access Memory (“DRAM”).

The second processor node 110 may include a CPU 112, a memory 114, and an RNIC 116. Although only one CPU 112 is illustrated in the processor node 110, those of ordinary skill in the art will appreciate that multiple CPUs may be included therein. The CPU 112, which may include a plurality of processors, may be connected to the memory 114 and the RNIC 116 over an internal bus or connection. The memory 114 may be utilized to store information for use by the CPU 112, the RNIC 116 or other systems or devices. The memory 114 may utilize various types of memory such as SRAM or DRAM.

The switch network 118 may include any combination of hubs, switches, routers and the like. In FIG. 1, the switch network 118 comprises switches 120A-120C. The switch 120A connects to the switch 120B, the RNIC 108 of the first processor node 102, the RNIC 124 of the I/O device 126 and the RNIC 128 of the I/O device 130. In addition to its connection to the switch 120A, the switch 120B connects to the switch 120C and the RNIC 132 of the I/O device 134. In addition to its connection to the switch 120B, the switch 120C connects to the RNIC 116 of the second processor node 110 and the RNIC 136 of the I/O device 138.

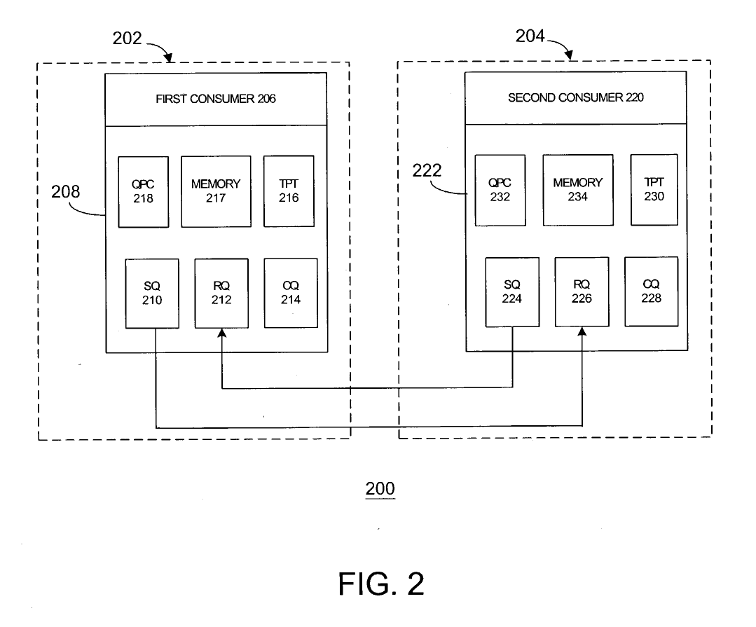

Each of the processor nodes 102 and 110 and the I/O devices 126, 130, 134, and 138 may be given equal priority and the same access to the memory 106 or 114. In addition, the memories may be accessible by remote devices such as the I/O devices 126, 130, 134 and 138 via the switch network 118. The first processor node 102, the second processor node 110 and the I/O devices 126, 130, 134 and 138 may exchange information using queue pairs (“QPs”). The exchange of information using QPs is explained with reference to FIG. 2.

FIG. 2 is a block diagram that illustrates the use of a queue pair to transfer data between devices in accordance with embodiments of the present invention. The figure is generally referred to by the reference numeral 200. In FIG. 2, a first node 202 and a second node 204 may exchange information using a QP. The first node 202 and second node 204 may correspond to any two of the first processor node 102, the second processor node 110 or the I/O devices 126, 130, 134 and 138 (FIG. 1). As set forth above with respect to FIG: 1, any of these devices may exchange information in an RDMA environment.

The first node 202 may include a first consumer 206, which may interact with an RNIC 208. The first consumer 206 may comprise a software process that may interact with various components of the RNIC 208. The RNIC 208, may correspond to one of the RNICs 108, 116, 126, 130, 134 or 138 (FIG. 1), depending on which of devices associated with those RNICs is participating in the data transfer. The RNIC 208 may comprise a send queue 210, a receive queue 212, a completion queue (“CQ”) 214, a memory translation and protection table (“TPT”) 216, a memory 217 and a QP context 218.

The second node 204 may include a second consumer 220, which may interact with an RNIC 222. The second consumer 220 may comprise a software process that may interact with various components of the RNIC 222. The RNIC 222, may correspond to one of the RNICs 108, 116, 126, 130, 134 or 138 (FIG. 1), depending on which of devices associated with those RNICs is participating in the data transfer. The RNIC 222 may comprise a send queue 224, a receive queue 226, a completion queue 228, a TPT 230, a memory 234 and a QP context 232.

The memories 217 and 234 may be registered to different processes, each of which may correspond to the consumers 206 and.220. The queues 210, 212, 214, 224, 226, or 228 may be used to transmit and receive various verbs or commands, such as control operations or transfer operations. The completion queue 214 or 228 may store information regarding the sending status of items on the send queue 210 or 224 and receiving status of items on the receive queue 212 or 226. The TPT 216 or 230 may comprise a simple table or an array of page specifiers that may include a variety of configuration information in relation to the memories 217 or 234.

The QP associated with the RNIC 208 may comprise the send queue 210 and the receive queue 212. The QP associated with the RNIC 222 may comprise the send queue 224 and the receive queue 226. The arrows between the send queue 210 and the receive queue 226 and between the send queue 224 and the receive queue 212 indicate the flow of data or information therebetween. Before communication between the RNICs 208 and 222 (and their associated QPs) may occur, the QPs may be established and configured by an exchange of commands or verbs between the RNIC 208 and the RNIC 222. The creation of the QP may be initiated by the first consumer 206 or the second consumer 220, depending on which consumer desires to transfer data to or retrieve data from the other consumer.

Information relating to the configuration of the QPs may be stored in the QP context 218 of the RNIC 208 and the QP context 232 of the RNIC 222. For instance, the QP context 218 or 232 may include information relating to a protection domain (“PD”), access rights, send queue information, receive queue information, completion queue information, or information about a local port connected to the QP and/or remote port connected to the QP. However, it should be appreciated that the RNIC 208 or 222 may include multiple QPs that support different consumers with the QPs being associated with one of a number of CQs.

To prevent interferences in the memories 217 or 234, the memories 217 or 234 may be divided into memory regions (“MRs”), which may contain memory windows (“MWs”). An entry in the TPT 216 or 230 may describe the memory regions and may include a virtual to physical mapping of a portion of the address space allocated to a process. These memory regions may be registered with the associated RNIC and the operating system. The nodes 202 and 204 may send a unique steering tag (“STag”) to identify the memory to be accessed, which may correspond to the memory region or memory window.

The STag may be used to identify a buffer that is being referenced for a given data transfer. A tagged offset (“TO”) may be associated with the STag and may correspond to an offset into the associated buffer. Alternatively, a transfer may be identified by a queue number, a message sequence number and message offset. The queue number may be a 32-bit field, which identifies the queue being referenced. The message sequence number may be a 32 bit field that may be used as a sequence number for a communication, while the message offset may be a 32-bit field offset from the start of the message.

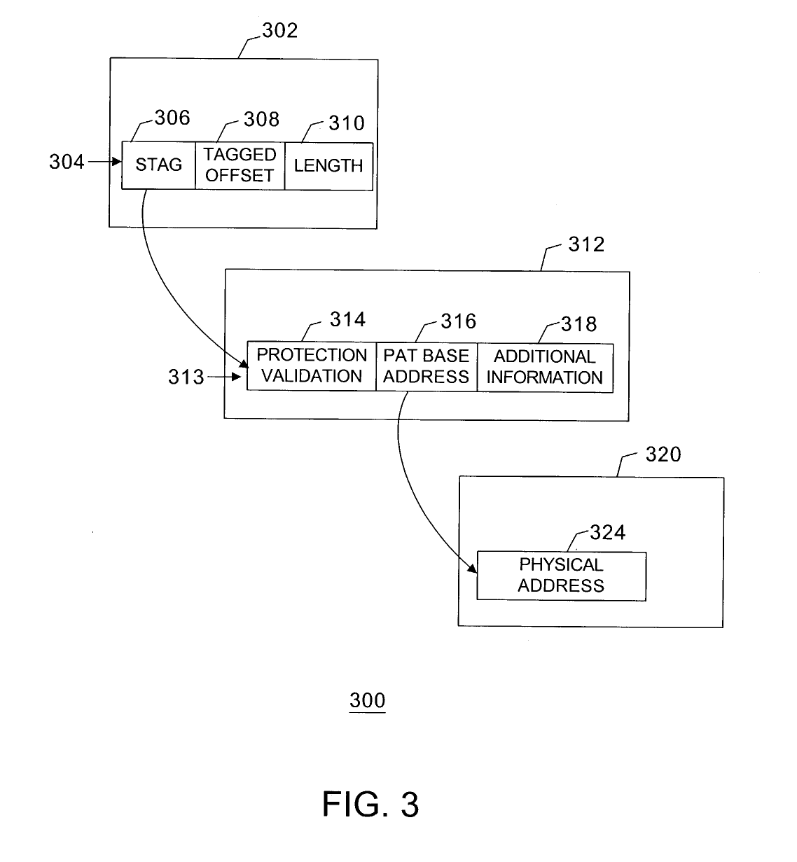

To obtain access to one of the memories 217 and 234, the consumer 206 or 220 may issue a verb or command that may result in the generation of a request, such as an RDMA read or write request or a work request (“WR”). For example, the request may be a WR, which may include a list of memory locations that may have data that is to be accessed. This list, which may be referred to as a scatter/gather list (“SGL”), may reference the TPT 216 or 230. The SGL may be a list or collection of information in a table or array that may point to local data segments of the memory 217 or 234. For instance, each element in the SGL may include a local STag, local tagged offset (i.e. virtual address), and length. Address translation in the context of virtual addressing and physical addressing is explained with reference to FIG. 3.

To perform a memory access, various pages of memory 217 or 234 may be registered. Registration may be a time consuming process that consumes computing resources and creates excessive entries in the TPT 216 or 230 or the like. FIG. 3, which is generally referred to by the reference numeral 300, includes information that may be used in performing virtual or physical address translation in a computer network such as the computer network 100 (FIG. 1).

FIG. 3 is a block diagram showing the processing of a memory request and associated TPT information for in accordance with embodiments of the present invention. The diagram shown in FIG. 3 is generally referred to by the reference numeral 300. A request 302 may correspond to a memory access operation and may include an SGL element 304. The SGL element 304 may include information, such as a steering tag (“STag”) 306, a tagged offset 308, and a length 310. Accesses to one of the memories 217 or 314 may require virtual addressing to correctly access the desired address range if the requesting client or process has no data about the physical address configuration of the memory being accessed. On the other hand, some memory accesses by clients or processes that have data on the physical address configuration of the memory being accessed may be able to access the correct memory locations in the relevant memory using physical addressing only. The STag 306 may comprise an address mode field that may be used to signify whether virtual addressing or physical addressing is required. The STag 306 may include steering information such as an STag to relate to specific memory locations. The tagged offset 308 (“TO”) may identify the offset in an appropriate buffer or, alternatively, a physical address.

The STag 306 within the SGL element 304 may correspond to an entry within a TPT 312, which may correspond to the TPTs 216 and 230 of FIG. 2. A TPT entry (“TPTE”) 313 may describe an associated memory region or memory window. The TPTE 313 may include a group of protection validation bits 314, a physical address table (“PAT”) base address 316 and additional information 318. The additional information 318 may include access controls, key instance data, protection domain data, window reference count, physical address table size, page size, first page offset, length, steering tag, or a physical address table pointer, for example. The protection validation bits 314 may be used to associate a QP that is involved in a data transfer and to validate that physical addressing is authorized for a given data transfer.

The PAT base address 316, which may correspond to a base address of the physical address table 320, may be combined with a portion of the TO 308 to index the PAT 320. In response, the PAT 320 may return a corresponding physical address. The combination of the PAT base address 316 with at least a portion of the TO 308 may be an arithmetic combination that is subject to adjustment depending on attributes of the associated memory region or memory window addressing mode. Accordingly, the PAT 320 may provide access to physical memory locations.

If physical addressing is available, the additional translation steps to transform a virtual address into a physical address may not be needed. When physical addressing is requested, the STag 306 may function as an address mode field to indicate that physical mode addressing is being requested for the associated memory access. Physical addressing, if appropriate, may reduce computing overhead by eliminating access to the physical address table 320 and the TPT 312. If physical addressing is indicated by the address mode field (for example, the STag 304), address translation may be avoided because the desired physical address may be embedded in the SGL element 304. For example, the desired physical address may be contained in the tagged offset field 308.

Physical addressing may be requested by designating a predetermined value to be used in the STag field 306. In this manner, the STag field 306 may function as an address mode field. If the STag field 306 corresponds to the predetermined value, physical addressing is required and processing may continue without additional address translation steps. If the STag field 306 does not correspond to the predetermined value indicative of physical addressing, virtual address translation may be performed in the normal manner.

Embodiments of the present invention may provide memory protection by validating that physical mode addressing is authorized when a request for physical mode addressing is received. For example, the QP context of a QP requesting physical mode addressing may contain a field indicating that physical mode addressing is allowed for that QP. That field may be coded when the QP is established.

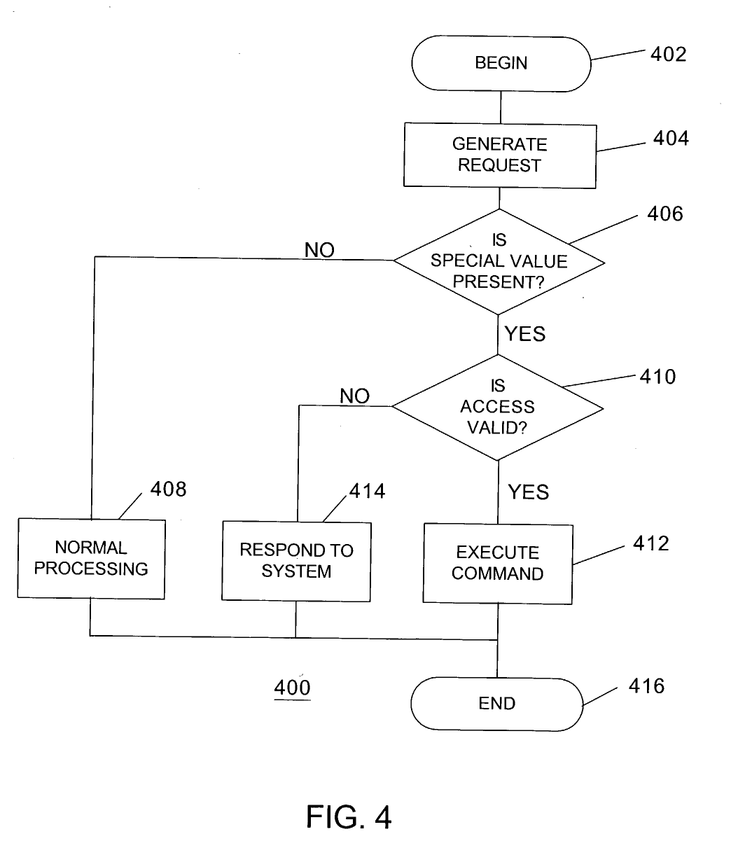

Turning to FIG. 4, a process flow diagram is illustrated to describe a process in accordance with embodiments of the present invention. In the diagram, generally referred to by reference numeral 400, physical mode addressing may be implemented and may be utilized in a computer network, such as the computer network 100. The process begins at block 402. At block 404, a request for access to a memory may be generated and that request may indicate through an address mode field that physical mode addressing is desired. For example, the address mode field may contain a predetermined value that corresponds to physical mode addressing. If physical mode addressing is requested, the request may contain a physical address to be accessed.

In response to the request, a determination may be made regarding whether the address mode field contains a value indicative of a physical address mode request (block 406). If the value of the address mode field does not correspond to a request for physical mode addressing, the request may go through normal processing at block 408. The normal processing may include translating the address mode field as though it corresponds to an STag.

If physical mode addressing is requested, a determination is made regarding whether the request is valid at block 410. The determination of whether the memory access is valid may involve validating the protection validation bits associated with specific queue pair participating in the memory access request. Also, separate validation bits may be used to enable remote or local physical mode addressing. If the access is valid, then the system may process the request using physical mode addressing, as shown at block 412. However, if the access is determined to be invalid, then the system may not execute the command and may respond to the system with a message at block 414. The message may be a local response that the request for memory access is invalid or an abort message or the lock. After either block 408, 412, or 414, the process may end, as shown at block 416.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. An address translation mechanism, comprising:
a request that corresponds to a memory access operation, the request including an address mode field; and
an address field that may be used as a virtual address or a physical address depending on the contents of the address mode field.

2. The address translation mechanism set forth in claim 1, wherein the address mode field is used to specify a steering tag (“STag”).

3. The address translation mechanism set forth in claim 1, wherein the address mode field is used to specify information about the memory access operation.

4. The address translation mechanism set forth in claim 1, wherein the address mode field is interpreted as a steering tag (“STag”) that identifies a region of memory unless a value in the address mode field corresponds to a predetermined value.

5. The address translation mechanism set forth in claim 1, wherein the address field is interpreted as a physical address if the address mode field corresponds to a predetermined value.

6. The address translation mechanism set forth in claim 1, wherein the request and a memory translation and protection table are used to relate the request to a section of memory if the address mode field does not correspond to a predetermined value.

7. The address translation mechanism set forth in claim 1, wherein the memory access operation is associated with a queue pair that has a queue pair context, the queue pair context including access validation data.

8. The address translation mechanism set forth in claim 1, wherein the request is a work request.

9. The address translation mechanism set forth in claim 1, wherein the request is an incoming remote direct memory access request.

10. A computer network, comprising:
a plurality of computer systems;
at least one input/output device;
a switch network that connects the plurality of computer systems and the at least one input/output device for communication; and
wherein the plurality of computer systems and the at least one input/output device comprises an address translation mechanism, the address translation mechanism comprising:
a request that corresponds to a memory access operation, the request including an address mode field; and
an address field that may be used as a virtual address or a physical address depending on the contents of the address mode field.

11. The computer network set forth in claim 10, wherein the address mode field is used to specify a steering tag (“STag”).

12. The computer network set forth in claim 10, wherein the address mode field is used to specify information about the memory access operation.

13. The computer network set forth in claim 10, wherein the address mode field is interpreted as a steering tag (“STag”) that identifies a region of memory unless a value in the address mode field corresponds to a predetermined value.

14. The computer network set forth in claim 10, wherein the address field is interpreted as a physical address if the address mode field corresponds to a predetermined value.

15. The computer network set forth in claim 10, wherein the request and a memory translation and protection table are used to relate the request to a section of memory if the address mode field does not correspond to a predetermined value.

16. The computer network set forth in claim 10, wherein the memory access operation is associated with a queue pair that has a queue pair context, the queue pair context including access validation data.

17. The computer network set forth in claim 10, wherein the request is a work request.

18. The computer network set forth in claim 10, wherein the request is an incoming remote direct memory access request.

19. A method of addressing memory locations in a computer system, the method comprising:
processing a request that corresponds to a memory access operation, the request including an address mode field;
evaluating the address mode field;
using an address field as a physical address if the address mode field corresponds to a predetermined value;
using the address field as a virtual address if the address mode field does not correspond to a predetermined value.

20. The method set forth in claim 19, comprising including a steering tag (“STag”) as at least a portion of the address mode field.

21. The method set forth in claim 19, comprising using the address mode field to specify information about the memory access operation.

22. The method set forth in claim 19, comprising interpreting the address mode field as a steering tag (“STag”) that identifies a region of memory unless a value in the address mode field corresponds to a predetermined value.

23. The method set forth in claim 19, comprising interpreting the address mode field as a physical address if the address mode field corresponds to a predetermined value.

24. The method set forth in claim 19, comprising using the request and a memory translation and protection table to relate the request to a section of memory if the address mode field does not correspond to a predetermined value.

25. The method set forth in claim 19, comprising:
creating a queue pair;
creating a queue pair context that includes access validation data;
comparing the access validation data to the request to determine if the memory access operation is valid.

26. The method set forth in claim 25, comprising:
performing the memory access operation if the comparison if the memory access operation is valid.
